(19) United States
(12) Patent Application Publication
(10) Pub. No.: US 2003/0174747 A1
(43) Pub. Date: Sep. 18, 2003

(54) Low voltage laser driver

(76) Inventors: Theodore J. Wyman, Mont Vernon, NH (US); Fouad Kiamilev, Hockessin, DE (US)

Correspondence Address: MORGAN & FINNEGAN, L.L.P., 345 Park Avenue, New York, NY, 10154-0053, US

(21) Appl. No.: 10/390,400

(22) Filed: Mar. 17, 2003

Related U.S. Application Data
(60) Provisional application No. 60/365,467, filed on Mar. 18, 2002.

(51) Int. Cl. H01S 3/13; H01S 3/00

(52) U.S. Cl. 372/38.01

(57) ABSTRACT

A driver circuit having a single power source that can be used with multiple types of laser devices each having different turn-on voltages.

### FIELD OF THE INVENTION

The present invention relates generally to integrated semiconductor circuits, and relates more particularly to laser driver circuits.

### CROSS REFERENCE TO RELATED APPLICATIONS

This application claims priority under 35 USC 119(e)(1) of U.S. Provisional Patent Application Serial No. 60/365,467 filed Mar. 18, 2002.

### BACKGROUND

Today's electronics have been evolving towards a low operating voltages in order to conserve power and to properly take advantage of new and improving low-voltage, high frequency IC processes. Whereas, in the past, 5V has been the typical supply power for many integrated circuits, current technology operates at 3.3V or less. FIG. 1 is a schematic diagram of a laser driver circuit of the prior art. The circuit mainly has three sections. The transistors Q1, Q2, and Q3 constitute a differential amplifier section, while Q4-Q7 constitute a emitter follower level shifter, and Q8-Q13 is a differential laser driver circuit. Q3, Q5, Q7, and Q12-Q13 are current sources. The differential pair Q1 and Q2 provides voltage gain by switching the current going through Q3 through either R1 or R2 depending on the inputs IN_P and IN_N. Q4 and Q6 are emitter followers that provides level shifting and current amplification to drive the output transistors Q10 and Q11. Q4 and Q6 accomplishes this current amplification by having a input impedance than is much larger than the output impedance, which means that the emitter follower stage can drive the output stage with little power from the input stage. The laser depicted in FIG. 1 is a vertical cavity surface emitting laser (VCSEL) that requires a 1.7V forward bias to begin lasing and has about a 50 to 200 ohm internal resistance. At currents required for proper optical output, approximately a total of 2.3V is needed to drive the laser. Currently, standard supply voltage for optical device systems is only 3.3V. This means that when the laser is operating nominally, the collector voltage of Q10 and Q11 are approximately 1V. However, the base voltages of Q10 and Q11 are nominally at 2.3V, much higher than the collector voltages. The base voltages of Q10 and Q11 are high because the bases are connected to the emitters of Q4 and Q6, where the emitter voltage is a result of the voltage between the base and the emitter of Q4 and Q6, and the voltage across resistors R1 and R2.

When such a situation occurs where the collector voltage of a npn transistor is lower than the base voltage, the transistor is said to be operating in the saturation region. Saturation occurs when both diode junctions across the emitter to the base and across the collector to the base are forwarding biased and conducting. A npn transistor in the saturation region acts essentially as a short circuit, with a large collector current and little voltage across the emitter and collector.

In the laser driver of FIG. 1, having transistors, such as Q10 and Q11, operating in the saturation region is undesirable, because the transistors can no longer properly switch the current to the high and low values necessary to turn the laser on or off. Proper current switching is done by inputting base currents to Q10 and Q11 and taking, as outputs, the collector currents of Q10 and Q11, where the collector current also flows to the emitter of Q10 and Q11. The relationship between the base current and the collector current in an npn transistor is given by:

I_{C}=βI_{B}

where I_{C} is the collector current and I_{B} is the base current. β, in this case, controls the relationship between the collector current and the base current. When the transistors are operating in the active region, that is to say, the collector voltage is greater than the base voltage and only the emitter-base diode junction is forward biased, β is approximately constant. However, when the transistors are operating in the saturation region, β can vary exponentially over a range of base current. This means that when Q10 and Q11 are in the saturation region, current switching cannot be properly performed since the output current is distorted by a variable β.

Currently, approaches to keep Q10 and Q11 in the active region are to raise the VCSEL power supply to a higher voltage, so that the collector voltages of Q10 and Q11 are higher than the base voltages. This method has the drawback that in order to use this laser driver circuit, two power supplies must now be provided, one at 3.3V to power the differential amplifier and emitter follower stage, and a higher voltage source to power the VCSEL laser. Unfortunately, voltage sources higher than 3.3V may not be available. Therefore, two power supplies is not typically a viable alternative and in any event, increases size, weight, and cost. Another solution would be to supply the entire circuit with 5V. However, this cannot be easily done since most current optical system can only supply 3.3V.

Another alternative method to avoid operating Q10 and Q11 in the saturation region is to change the parameters of Q1-Q7 and R1-R5 so that the base voltages of Q10 and Q11 are below 1V. This can be accomplished by changing the resistance values of R1-R2 or the current going through Q3. Using his method, the laser driver is now optimized to only function with VCSEL laser that requires 2.3V to operate properly. However, designing a circuit with little voltage difference between its nominal voltage and what is available, or the headroom, can compromise the performance of the device. For example, if the designer wishes to use this laser driver with a different type of laser that requires, for example, less than 2.1V to operate properly, the parameters of the transistors and resistors in the laser driver circuit have traded off a large headroom for a slower speed performance. If lasers with a smaller voltage drop become available, then the designer would have to redesign the circuit so that the headroom is smaller so that speed is improved.

### SUMMARY OF THE INVENTION

The disclosed invention solves the problem having transistors of a laser driver operating in the saturation region. The present invention uses a transistor with an adjustable gate voltage to pull current across R_{new} to lower the voltages Diff_n and Diff_p and hence the voltages at the bases of Q10 and Q11. These voltages can be adjusted as low as necessary so that Q10 and Q11 will not be saturated during the operation of the laser driver. When those base voltages fall below a certain point, the transistors will no longer be in saturation and the transistors will once again be capable of proper switching. The present invention also allows a user to easily trade off headroom for speed performance.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 is a schematic diagram of a laser driver circuit of the prior art;

FIG. 2 is a schematic diagram of an example laser driver circuit in accordance with the present invention; and

FIG. 3 is a schematic diagram of another embodiment of a laser driver circuit in accordance with the present invention.

### DETAILED DESCRIPTION

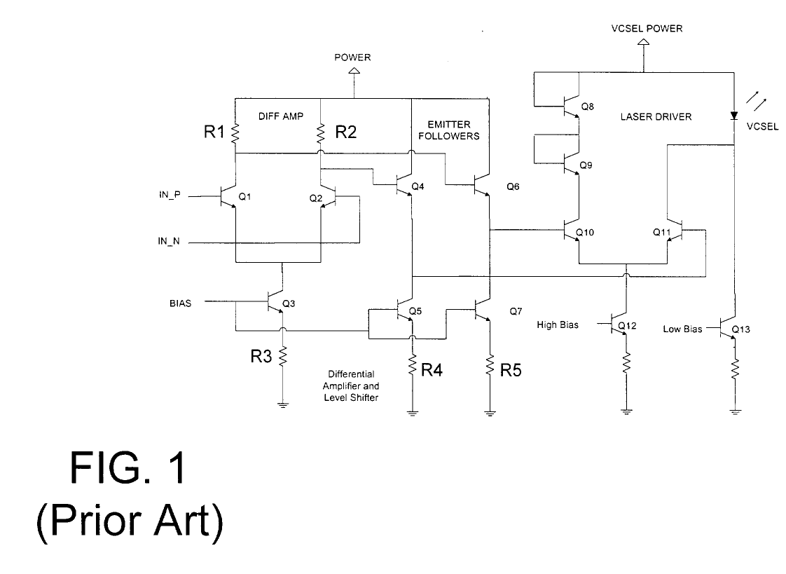

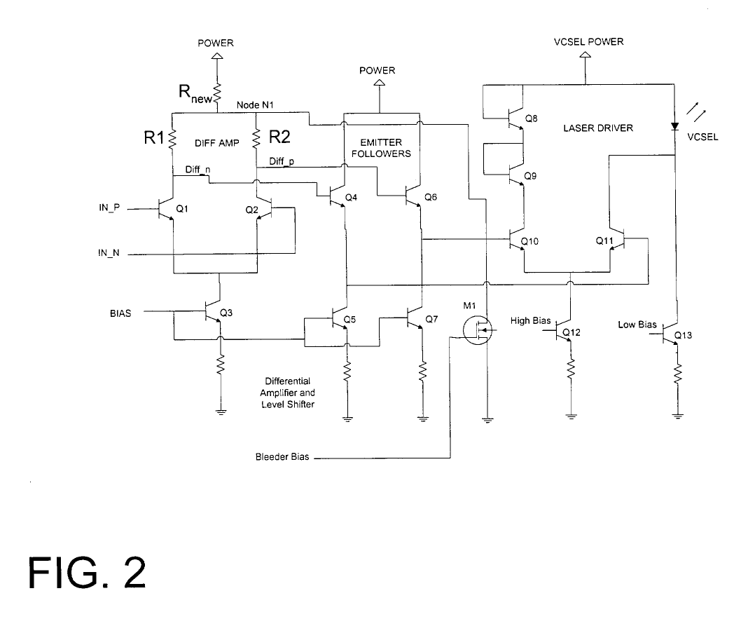

FIG. 2 is a schematic diagram of an example laser driver circuit in accordance with the present invention. The laser driver circuit is similar to that of FIG. 1 except it includes a resistor R_{new} above the load resistors R1 and R2, and a transistor M1, its drain connected to node N1, driven by an adjustable analog control Bleeder Bias. In this example, M1 is shown as a metal oxide semiconductor field effect transistor (MOSFET), although a bipolar junction transistor could be substituted in an alternative embodiment. When transistor M1 is on, it draws current through R_{new}, lowering the voltage of N1. The amount of the current drawn by M1 is controlled by the Bleeder Bias. Specifically:

I_{D}=k(V_{GS}−V_{T})²

where I_{D} is the drain current of M1, V_{GS} is the voltage difference between the gate and the source, V_{T} is a constant threshold voltage of the transistor, and k is a scaling factor. In the case of a FET, V_{T} and k depends on the innate properties of the transistor such as geometry and size. Also note that the FET is operating in the saturation region, as it is desirable to operate a FET in the saturation region.

The operation of the bleeder transistor M1 is as follows. As the Bleeder Bias voltage increases, the current I_{D} also increases. I_{D} is the same current that is going to ground from node N1. As I_{D} increases, the voltage drop across R_{new} increases, thereby the voltage at node N1 is decreased. The lower voltage at N1 results in lower voltages at Diff_n and Diff_p, which in turn lowers the voltages at the bases of Q10 and Q11. So through this chain of events the current through M1 adjusts the base voltages of Q10 and Q11.

The laser driver of the present invention is therefore more generic in that it can be easily used with different types of laser devices having different switch on voltages because the Bleeder Bias voltage can be easily changed so that the base voltages of Q10 and Q11 fall below the collector voltages. Moreover, only one voltage supply of 3.3V is needed. Only the Bleeder Bias voltage need to be changed in order for the laser driver to function with those different lasers. For example, if a laser is used having a small turn on voltage, for example 1.3V, the Bleeder Bias voltage can also be adjusted to be small since the base voltage of Q10 and Q11 can be as much as 2V. But if a laser is used having a large turn on voltage, for example 2.6V, then the Bleeder Bias voltage will have to be adjusted to be larger so that the base voltages of Q10 and Q11 will have to be smaller than 0.7V.

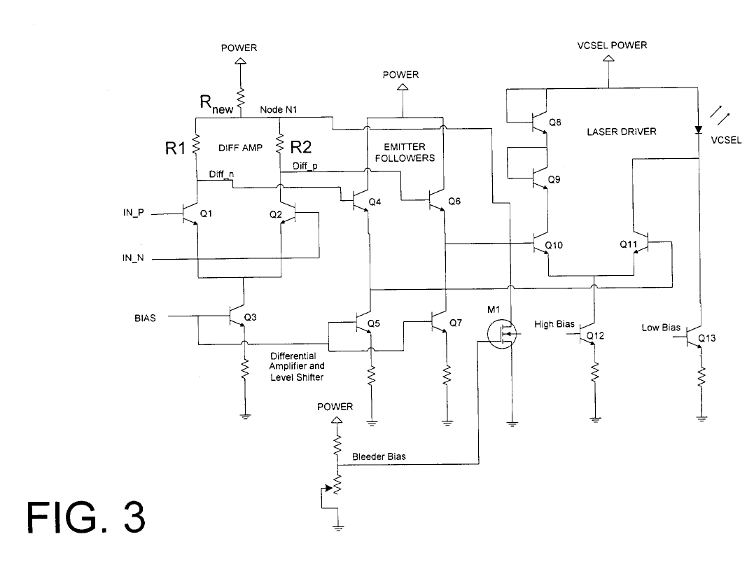

FIG. 3 is a further alternative example of the circuit of FIG. 2. In the example of FIG. 3, a variable resistor is added so that the Bleeder Bias voltage can be made to be controlled externally.

It should be understood that the above description is only representative of illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention and others are equivalent.

What is claimed is:

1. A driver circuit for use with multiple types of laser devices each having different turn-on voltages comprising:
a single power supply source;
a switching circuit comprising
a) a differential amplifier stage, coupled to the single power supply source, and having an input, an output, and a pair of load resistors;
b) an emitter follower level shifter stage, coupled to the single power supply source, having an input and an output, wherein the input of the emitter follower level shifter stage is coupled to the output of the differential amplifier stage;
a resistor, located between the power supply source and the load resistors;
a laser drive stage including a laser of one of the multiple types of laser devices having a specific turn-on voltage, the laser drive stage being coupled to the single power supply source and driven by the emitter follower level shifter stage;
a bleeder transistor, coupled to the switching circuit between the resistor and the load resistors to account for the specific turn on voltage based upon a bias voltage for the bleeder transistor.

2. The driver circuit of claim 1 further comprising:
an externally controllable variable resistor coupled to the bleeder transistor which, when varied, adjusts the bias on the bleeder transistor.

3. The driver circuit of claim 1 wherein the bleeder transistor comprises a field effect transistor.

4. The driver circuit of claim 3 wherein the field effect transistor is a Metal Oxide Field Effect Transistor (MOSFET).

5. The driver circuit of claim 1 wherein the single power supply voltage source is a 3.3volt voltage source.
